(19) United States
(12) Patent Application Publication
(10) Pub. No.: US 2005/0240713 A1
(43) Pub. Date: Oct. 27, 2005

(54) Flash memory device with ATA/ATAPI/SCSI or proprietary programming interface on PCI express

(75) Inventors: Teresa Wu, Cupertino, CA (US); Sin-Shain Cho, Cupertino, CA (US)

Correspondence Address: Bo-In Lin, 13445 Mandoli Drive, Los Altos Hills, CA, 94022, US

(73) Assignee: V-DA Technology

(21) Appl. No.: 11/102,956

(22) Filed: Apr. 11, 2005

Related U.S. Application Data
(60) Provisional application No. 60/564,633, filed on Apr. 22, 2004.
(60) Provisional application No. 60/565,946, filed on Apr. 28, 2004.

(51) Int. Cl. G06F 13/36

(52) U.S. Cl. 710/314

(57) ABSTRACT

A storage device made of flash memory module(s) and a storage device controller and a PCI Express interface unit, is implemented to be compatible with (1) either ATA, ATAPI, SCSI or proprietary specification, and (2) PCI Express platform such as, with then, ExpressCard Standard or PCI Express Card Specification or PCI Express Mini Card Specification. The device includes memory module(s), which can accept data transfer and configuration and status report to/from non-volatile solid-state memory herein referred to as flash memory module(s). The storage device controller and the PCI Express interface unit work together to provide (A) PCI Express interface functionality and compatibility, and (B) ATA, ATAPI or SCSI or proprietary programming interface functionality and compatibility, alone with common flash memory operations such as programming reading, writing, erasing, and data transferring from/to PCI Express host platform.

This Application is a Formal Application and claims a Priority Filing Date of Apr. 22, 2004 benefited from a previously filed Application 60/564,633 and another Priority Filing Date of Apr. 28, 2004 benefited from another previously filed Application 60/565,949. Both of these applications were previously filed by one of the common inventors of this patent application.

### BACKGROUND OF THE INVENTION

1. Field of the Invention

The invention relates generally to the memory device implemented with a host data handling system such as a notebook computer, a desktop computer or a server. More particularly, this invention relates to erasable and programmable nonvolatile semiconductor memory devices connected to a host platform using ATA/SCSI/ATAPI or proprietary programming interface via PCI Express interface.

2. Description of the Prior Art

Even though there have been tremendous advancements made in the technologies of portable external data storage devices adaptable to a host such as a notebook computer, a desktop computer or a server, the data storage technologies are still confronted with several technical limitations and difficulties. Specifically, some of the limitations currently confronted in the industries are the speed of data transfer, the inability to simultaneously read and write data, and the requirement for a driver in the host system to operate the device. There is an urgent need to resolve these technical limitations. Particularly, with the increase of the data storage capacity of the storage device and the increased data processing speed of the host computers, the limited data transfer rate become a sever bottleneck to the performance of a host system when operated with an externally adaptable data storage device currently available.

Erasable and programmable non-volatile semiconductor memory devices, generally referred to as flash memory, are used for storage of information. Flash memories include electrically erasable and programmable read-only memories (EEPROMs) made of flash-type, floating-gate transistors and are non-volatile memories similar in functionality and performance to EPROM memories, with an additional functionality that allows an in-circuit, programmable, operation to erase pages of the memory. In order to connect flash memory device to host platform directly, many different ways and interfaces are implemented. The more popular interfaces are UFD (USB Flash Drive) and PCMCIA (Personal Computer Memory Card International Association). Both implementations have drawbacks, including difficulty of use, high cost and performance limitation.

More recently, the UFD (USB Flash Drive) and the compact flash (CF) card are commonly available portable data storage devices that can be conveniently carried around and externally adaptable to a personal computer. FIG. 1A is a functional block diagram for illustrating the interfaces between a host personal computer 10 and these data storage devices, e.g., a USB device 15 and a compact flask (CF) device 20. As shown in FIG. 1A, the host system is required to provide USB host controller and PC-card CardBus host controller to interface with the device controllers in order to interface with these devices. Additionally, a USB host device driver and a CardBus host device driver have to be installed in the host system 10 in order to operate these data storage devices.

Referring to FIG. 1B for a typical architecture and transport protocol stacks in a conventional mass storage implemented in a computer system today. The host 10 includes a peripheral host bus adaptor (PHBA) 40 that further includes a host bus module 45, a peripheral host controller 50 and a peripheral bus module 55. The host functions as a master to interact with a peripheral storage device 80 functioning as slave. Operated with this architecture, the storage media such as flash memory or magnetic disks are connected to the peripheral device controller 50′ to handshake and running protocols between the peripheral device controller 50′ and the host bus adapter 40. Four levels of protocols are implemented between the host 10 and the peripheral storage device 80. These four level of protocols are: 1) physical link between the peripheral bus module 55 and the peripheral bus 55′; 2) data link between the peripheral host controller 50 and peripheral device controller 50′; 3) a transaction link between a peripheral host controller device driver 60 and a peripheral controller device driver 60′; and 4) a mass storage link between an operation system (OS) mass storage device driver and a storage class F/W 70′. In each of these four layers, Layer-i where i=1, 2, 3, 4, on the host 10 carries on a conversation with layer-i on mass storage peripheral 80. The rules and conventions used in this conversation are collectively known as the layer-i protocol, as illustrated in FIG. 1B. The entities included in corresponding layers on host and mass storage peripheral are called peer processes. In reality, no data are directly transferred from one layer-i on host to layer-i on mass storage peripheral. Instead, each layer passes data and control information to the layer immediately below it, until the lowest layer is reached. Below layer-1 is the physical medium through which actual communication occurs. In FIG. 1B, virtual communication is shown by dotted lines and physical communication by solid lines. The peripheral host bus adapter 40 initiates and controls all storage transport protocol processes. The peripheral device controller 50′ receives and executes commands sent from the peripheral host bus adapter 40.

According to above architecture and protocol links, because of the requirements on the host system to provide a USB host controller and a PC-card CardBus host controller, the USB flash memory device and the CF card must each has its own external-device adapter. These external adapters for adapting the devices into the host system must have hardware-specific form factors such that the external adaptable data storage devices can be compatibly operated with these host controllers. Therefore, limitations are imposed on the host system to provide different adapting slots in order to interface with different portable data storage devices.

Another limitation of the USB flash drive (UFD) and the compact flash card (CF) is the data transfer speed. The performance ceiling of data transfer for the UFD is 35 Mbytes per second and for the CF is 20 Mbytes per second. The transfer speeds become a bottleneck to many applications as the processor of the host system have significantly increased processing speed and continuously in a data-hunger state.

Furthermore, since the UFD and CF storage devices must be driven by the device driver under the control of the operating system (OS) of the host system, such devices have a further limitation that the devices cannot operate unless the host system has already been turned on with the operation system of the host system fully functional. These externally adaptable data storage device cannot be used to solve a problem currently faced by a computer user that there is long delay every time when a computer is turned on. The computer initialization takes at least few minutes to “boot up”. Even with increased processing speed, such delay cannot be easily shortened because concurrently to the increase of the processing speed of the central processor, more complex system configuration and device operations are added to the host system. The processes of initializing the host system having a configuration with more hardware and software applications inevitably takes longer time even with higher speed processors.

Therefore, a need still exists in the computer design and system configuration to provide a new and improved implementation of the memory devices such that the above-mentioned difficulties and limitations can be resolved.

### SUMMARY OF THE PRESENT INVENTION

It is therefore an object of the present invention to provide a new device interface configuration and system design for connecting and operating an externally adaptable data storage device such that the device can be more conveniently used for different host platforms. Specifically, a PCI Express interface is implemented that provides three versatile connector form-factors: PCI Express Card for desktop computer and server, ExpressCard for laptop and mobile computer and PCI Express Mini Card for replacing Mini-PCI. Such implementation overcomes the difficulties of the conventional technologies as neither UFD nor CF interface can provide such versatile form-factors for flash memory device connectivity at different host platforms.

It is another object of this invention to provide a data storage device with higher data transfer rate. The performance of PCI Express can reach up to 2.5 Gb/s (2,500 Mb/s); therefore, the data transfer rate for a system of this invention is significantly higher than that can is achievable by either the UFD or CF devices.

It is a further object to provide new and improved data storage device implemented as a host bus device that does not depend on a bus host controller to operate such that the data storage device can be implemented to boot up a computer thus significantly reduce the delay of initialization and turning on of a host system such that the limitations of the conventional methods can be overcome.

It is another object to provide new and improved data storage device and interface configurations such that the device can be easily plugged and played with legacy operation systems. This is achieved by adding an ATA/ATAPI/SCSI System Task Controller to take advantage and utilize the existing ATA device driver or SCSI device driver or ATAPI device driver, and make it backward compatible with legacy OS without the request of new device driver installation.

The present invention is of a flash memory device, containing one or more flash modules, in which the flash memory is mapped to the address space of a system task controller with ATA programming interface or ATAPI programming interface or SCSI programming interface or proprietary programming interface which has a PCI Express-defined interface. This flash disk controller supports the PCI Express functionality according to the PCI Express standard and specifications (with then, but not limited to, ExpressCard Standard and PCI Express Card Specification and PCI Express Mini Card Specification), thereby supporting enumeration onto the PCI Express specifications, as well as data reception and transmission over PCI Express interface to and from PCI Express endpoints.

This system task controller also supports either ATA programming interface or ATAPI programming interface or SCSI programming interface or proprietary programming interface services and the functionality, and control of the flash memory device, as well as the processing of PCI Express commands and data packets from/to the host platform. Thus, the entire device acts as a dynamically attachable/detachable non-volatile ATA storage device, or ATAPI storage device, or SCSI storage device, or proprietary storage device for the host platform.

In a preferred embodiment, the present invention discloses a flash memory device that includes (a) a PCI Express or ExpressCard or PCI Express Mini Card connector for connecting to the PCI Express-defined bus; (b) a PCI Express interface unit for signal/data processing between said PCI Express or ExpressCard connector and said storage device controller; (c) a storage device controller for controlling said at least one flash memory module and for providing either ATA programming interface or ATAPI programming interface or SCSI programming interface or proprietary programming interface, and for controlling said PCI Express interface unit; (d) at least one flash memory module for storing data.

Briefly in a preferred embodiment this invention discloses a memory device for adapting to a host computer operated with an operating system. The memory device includes a storage-device host controller provided for interfacing with the operating system (OS) of the host computer by employing peer-to-peer link protocols for transferring data between the memory device and the host computer. In a preferred embodiment, the memory device is an externally adaptable memory device for detachably adapting to the host computer. In a preferred embodiment, the peer-to-peer link protocols further includes peer-to-peer link protocols defined in a PCI Express Standard. In another preferred embodiment the memory device further includes a host bus memory device and the peer-to-peer link protocols further include host bus protocols. In a preferred embodiment, the host bus protocols further includes peer-to-peer link protocols defined in a PCI Express Standard. In a preferred embodiment, the memory device further includes an adapting link provided for adapting the memory device to the host computer by attaching to a bus interface of the host computer for transferring the data between the memory device and the host computer and for employing the peer-to-peer link protocols. In another preferred embodiment the memory device further includes a PCI Express Interface adapting link provided adapting the memory device to the host computer by attaching to a PCI Express Interface bus interface of the host computer for transferring the data between the memory device and the host computer and for employing the peer-to-peer link protocols as defined in a PCI Express Standard. In another preferred embodiment the storage-device host controller provided for interfacing with the operating system (OS) of the host computer by employing peer-to-peer link protocols is further provided for carrying out a simultaneously bi-directional data transfer between the memory device and the host computer.

This invention further discloses a method for booting a host computer. The method includes steps of A) adapting an external detachably adapting device to the host computer and enabling the external detachably adapting device to interface with the host computer through exchanging peer-to-peer protocols; and B) storing data operating system in external detachably adapting device ready to load into host computer immediately for booting up after a power-on operation of the host computer.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A and 1B are a functional block diagrams for illustrating the conventional interface and protocol links between a host computer system and a peripheral data storage device.

FIGS. 2 and 3A to 3C are a functional block diagrams for illustrating the interface and protocol links between a host computer system and a peripheral data storage device of the present invention.

FIGS. 4A to 4D are functional block diagrams for showing additional configurations for allowing peripheral devices to interface as a peer-to-peer device with a host computer.

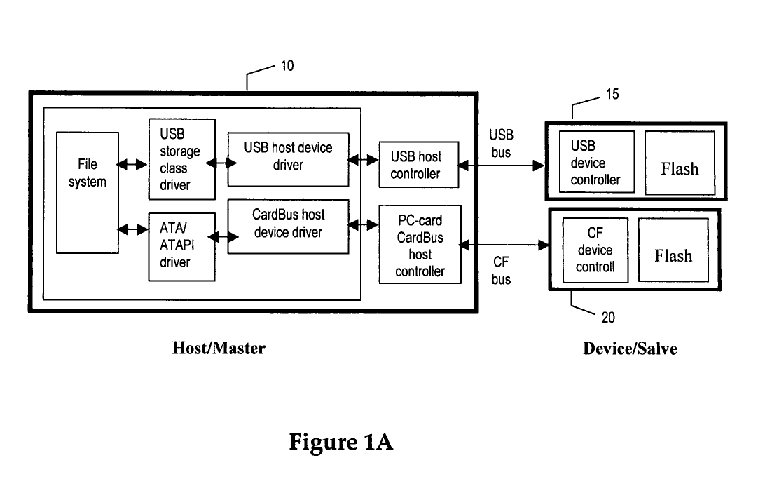

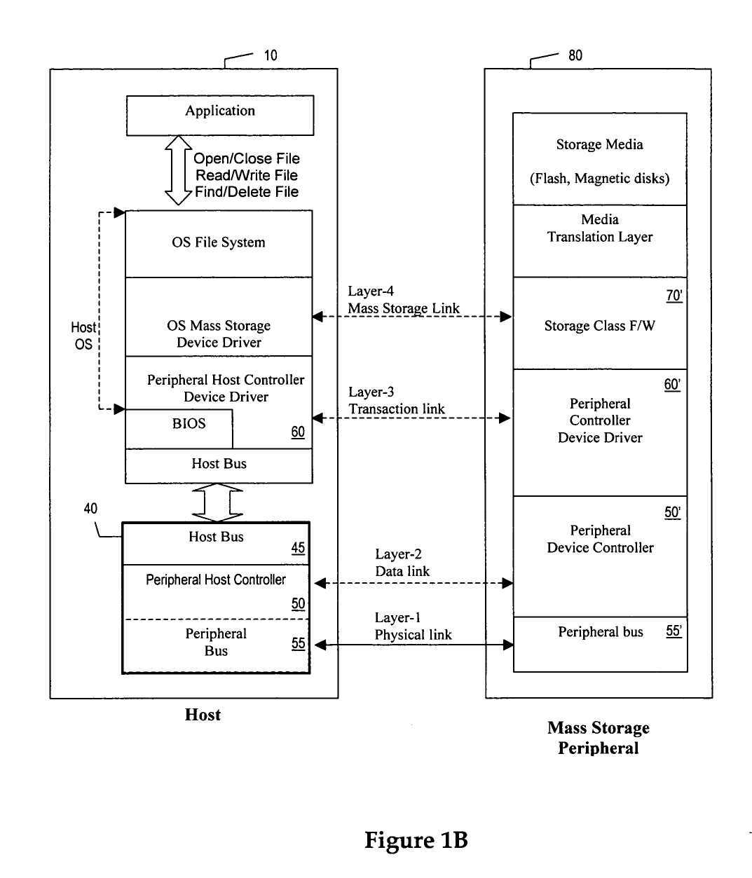

### DETAILED DESCRIPTION OF THE METHOD

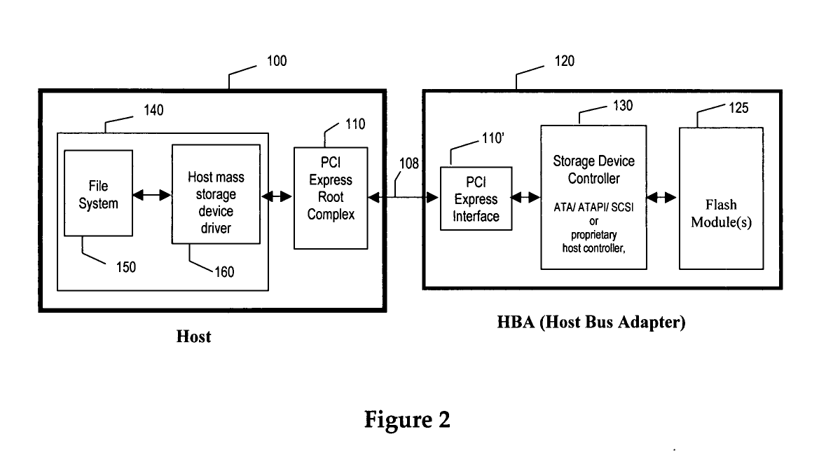

Referring to FIG. 2 for a functional block diagram for showing host computer 100 interfaces through a PCI Express link 108 to a memory device 120. The memory device can be an internal memory device as part of the host computer or as shown in FIG. 2, as an externally adaptable flash memory device 120. In a preferred embodiment, the memory device 120 includes a flash memory 125 controlled by a controller 130 that can be either an ATA/ATAP/SCSI host controller or a proprietary storage device controller. The host computer 100 is operated with an operation system (OS) 140 that controls the file system 150 and another host mass storage device driver 135′. The host mass storage device driver 135′ supports either an ATA/ATAP programming interface 160-1 or SCSI programming interface 160-2 or proprietary interface 160-3.

Base on the architecture as shown in FIG. 2, a READ operation of data from the flash memory 125 is processed by first retrieving data from the nonvolatile flash memory 125 and translated to storage protocol for communicating and sending data through the ATA/ATAP/SCSI host controller or a proprietary storage device controller 130. Then, the storage protocol is translated and the protocol and data are encapsulated into data packets according to the PCI Express protocol for transmitting through the PCI Express interface 110 and PCI Express link 108 to the host computer 100. Once the PCI Express data packages are delivered to host computer, the operating system 140 transmits the storage protocol packages to a host mass storage device driver 135′. The host mass storage device driver 135′ then decodes the storage protocol and transmits the data packages to OS file system 150 and completes the READ operation. A data WRITE operation is accomplished by carrying the processing steps in a reverse order. The READ and WRITE operations can be simultaneously carried out thus providing asynchronous data transfer between the host system 100 and the storage device 120.

Instead of the master/slave functional relationship as that implemented in the conventional UFD and CF system where the host computer functions as a master to drive the storage device with a host device driver, the configuration implemented in the present invention is a host bus adapter (HBA) configuration. The storage device 120 is adapted directly to the data bus through a HBA device and therefore does not require a host controller and host device driver executed by the host computer to control and drive the data storage device.

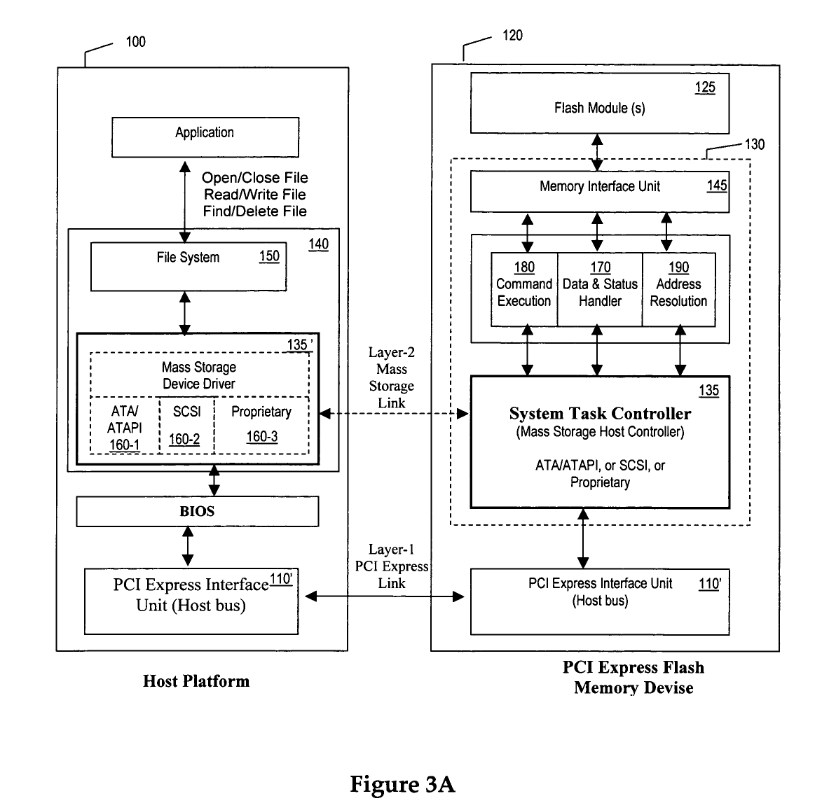

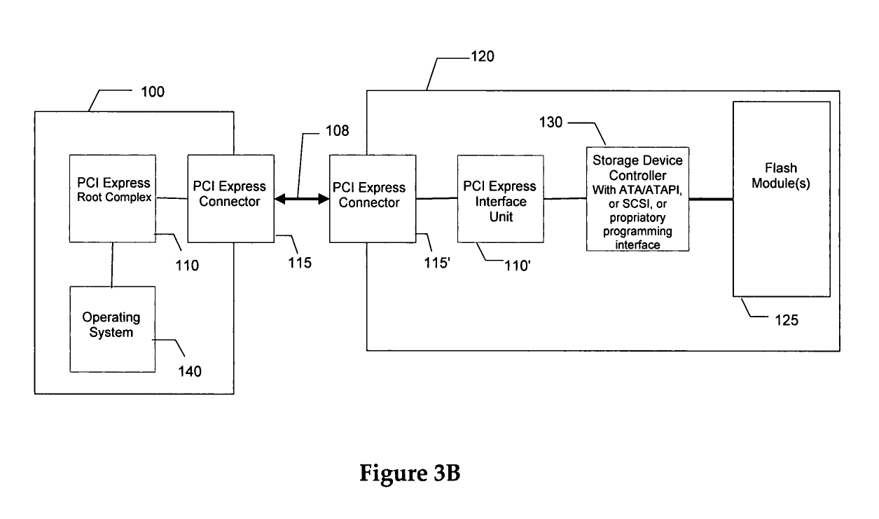

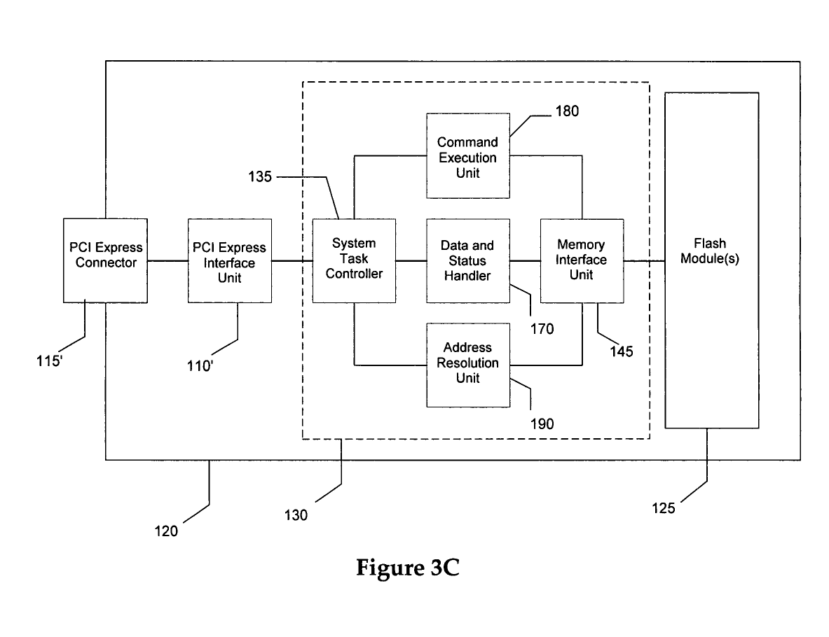

Referring to FIGS. 3A to 3C for a functional diagrams showing an architecture and protocol links implemented with host bus adapter (HBA) of this invention. The flash memory device 120 interfaces with the host 100 through the PCI Express interface unit 110′ plugged through two interfacing connectors, a PCI-Express connector 115′ disposed on the flash memory device 120 and a corresponding PCI Express connector 115 disposed on the host 100 to establish a PCI Express link 108. The PCI Express connector 115 is connected to the PCI Express interface unit 110 disposed on the host 100. The flash memory device 120 of this invention includes a host controller 130 as shown in FIG. 2 further includes a system task controller 135 to function as a mass storage host controller to execute and command the data access functions. The storage device controller 130 as shown is provided to apply one of several possible mass storage protocols either standard ATA/ATPI or SCSI or proprietary protocols.

There are two level of protocol interactions between the storage device 120 and the host 100: 1) a PCI Express link and 2) a mass storage link where the mass storage host controller 135 is interfacing with a mass storage device driver 135′ resides on the host 100. When the storage device 120 is connected to the host 100, a standard PCI Express handshake process takes place to establish a peer-to-peer link according to the PCI Express specification. This peer-to-peer link has the operational characteristics that either party in communication is enabled to take equal responsibilities for initiating, maintaining, and termination a session of communication. The peer-to-peer link is different from the “master-slave” communications where the master, e.g., a host computer, determines which users can initiate a certain types of communication sessions. In this peer-to-peer link, the host is programmed to allow the HBA (host bus adapter) to initiate all protocol sessions thus enable the communications to proceed with the peer-to-peer operational characteristics.

Once a PCI Express link is established, the host 100 enables the storage device controller 130 on the storage device 120 and further determines the capabilities of the device to start the interface with the storage device 120. After the system initiation and configuration processes, the operation system (OS) of the host 100 requests services by sending request packets to the PCI Express flash memory device 120. The storage device controller 130 disposed on the storage device 120 performs various operations such as reading writing or erasing data from or to flash memory module 125. Therefore, in this architecture, the host 100 does not require a mass storage host controller because the storage device 120 now has its own mass storage host controller to control and executes functions such as command executions, data status handling and address resolution function to interface with the flash module 125.

As that shown in FIG. 3A to 3C, the system task controller 135 is the core of mass storage host controller which uses one of several possible mass storage protocols, either standard ATA/ATPI/SCSI or proprietary one. The system task controller 135 handles ATA/ATAPI protocol, or SCSI protocol, or proprietary protocol requested from operating system through PCI Express interface unit 110, PCI Express link 108, and PCI Express interface unit 110′. A mass storage protocol, either ATA/ATAPI protocol or SCSI protocol or proprietary protocol, sent by operating system are carried on the PCI Express link 108.

In FIGS. 3A to 3C, the command-execution unit 180 handles the requests sent to the PCI Express Flash Memory Device 120 by operating system 140 in the host 100, in the form of read, write, erase, and the command execution unit interprets the configuration commands. A data and status handler 170 performs data related aspects of every received command from system task controller 135 and memory interface unit 145 and transports the data through system task controller 135 to and from flash memory module 125. Data and status handler 170 also performs error detection and correction routine for flash memory module 125 and for receiving status from system task controller 135, and for sending a status message concerning a status of flash memory module 125. A command execution unit 180 handles the commands, which involve data or an address, such as, read, write, erase and configuration commands. An address resolution unit 190 performs the address translation between the logical address space of operating system and physical address space of Flash module 125. The memory interface unit 145 receives commands and responses to the service requests received from command execution unit, data and status handler, address resolution unit and performs routines of read, write, erase and configuration to the physical address space of flash memory module. Memory interface unit 145 also responds to the status of Flash memory module 125 to command execution unit 180, data and status handler 170, address resolution unit 190 as well. All operations of the command execution unit 180, data status handler 170, address resolution unit 190 have to interoperate with the system task controller 135 and memory interface unit 145 to write, read, erase and configure the flash module 125.

The protocol transportations of the present invention include the corresponding layers on host and mass storage peripheral are known as peer processes. In reality, no data are directly transferred from one layer-n on host to layer-n on mass storage peripheral. In FIG. 3A, virtual communications are shown by dotted lines and physical communication by solid lines. There are two peer processes between host and PCI Express Flash Memory Device. Layer-1: PCI Express link layer. Layer-2: mass storage link layer. Between each pair of adjacent layers there is an interface that defines which primitive operations and services that the lower layer offers to the upper one. Each layer passes data and control information to the layer immediately below it, until the lowest layer is reached. The system task controller 135 is a peripheral host controller. The peripheral host controller of prior developments are integrated in host. The peripheral host controller of present invention is integrated with the externally adaptable storage device 120, e.g., the PCI Express Flash Memory Device.

Layer-1: PCI Express Link Layer

When PCI Express Flash Memory Device 120 connects to host 100, a standard PCI Express handshaking process takes place and establish peer-to-peer link according PCI Express specification. Thus, the PCI Express Flash Memory Device has been attached to host bus. The host bus is PCI Express according to present invention.

Layer-2: Mass Storage Link Layer

Once PCI Express Flash Memory Device 120 has been attached to host bus, operation system performs the following routines to identify where the PCI Express Flash Memory Device is, and complete the first step of mass storage link between PCI Express Flash Memory Device and host.

Initializes the system task controller. The system task controller 135 is a mass storage peripheral host controller. Every peripheral host controller has to be assigned a host bus I/O address space. According to the present invention, host assigns a PCI Express I/O address space to PCI Express Flash Memory Device. When the operating system initializes the system task controller, in the meanwhile the system task controller also performs an initiation routine to flash memory module 120 and determines the status, capacity and features of Flash memory module 120. The system task controller stores this information to a task file of system task controller.

Configures the system task controller. System task controller includes a command register block. The command register block stores a data structure called “Task File”. Task file is used to exchange command, messages or transport data between PCI Express Flash Memory Device and host. The task file comprises a status register, a data register, an error register, a feature register, a device control register, a sector count register, a LBA sector number register, a LBA cylinder register, a LBA head register, and command register. The data structure of task file can compatible with one of several possible mass storage protocols, either standard ATA/ATPI/SCSI or proprietary one.

The registers' functional description of task file of system task controller is listed as the following.

1. Status register
This register returns the system task controller status when read by host.
This register also read status from data and status handler 170.
2. Data register
This register is used to transfer data blocks between the data buffer of PCI Express Flash Memory Device and the host. This register also transfers data blocks from/to data and status handler 170.
3. Error register
This register contains additional information about the source of an error when an error is indicated in bit 0 of the Status register.
4. Feature register
This register provides information regarding features of the host can utilize.
5. Device control register
This register is used to control the system task controller interrupt request and to issue a software reset.
6. Sector count register
This register contains the numbers of sectors of data requested to be transferred on a Read or Write operation between the host and the system task controller.
7. LBA Sector number register
This register contains the starting sector number of the Logical Block Address (LBA) for address resolution unit 190 data access for the subsequent command.
8. LBA cylinder register
This register contains the of the starting cylinder address of the LBA addressing.
9. LBA Head register
This register contains the starting head address of LBA addressing.
10. Command register: Command Execution Unit
This register contains the command code being sent to Command Execution Unit 180. Command execution begins immediately after this register is written. Logical Block Addressing (LBA) is a method used to support mass storage drives on computer. LBA provides the necessary address conversion in the BIOS to support mass storage drives. BIOSs provide LBA conversion based on cylinder/head/sector addressing. LBA support is required for compatibility with OS file system.

After the completion of initiation and configuration of PCI Express Memory Device, operating system has the knowledge and capability to access PCI Express Memory Device as a host bus mass storage device through either standard host bus mass storage device driver or proprietary host bus mass storage device drivers. The standard host bus mass storage device driver is either ATA, or ATPI, or SCSI. According to the present invention, the storage device, e.g., the PCI Express Flash Memory Device as a preferred embodiment, can be configured and act either as a dynamically attachable/detachable flash storage peripheral, or a fixed Flash memory drive for the host.

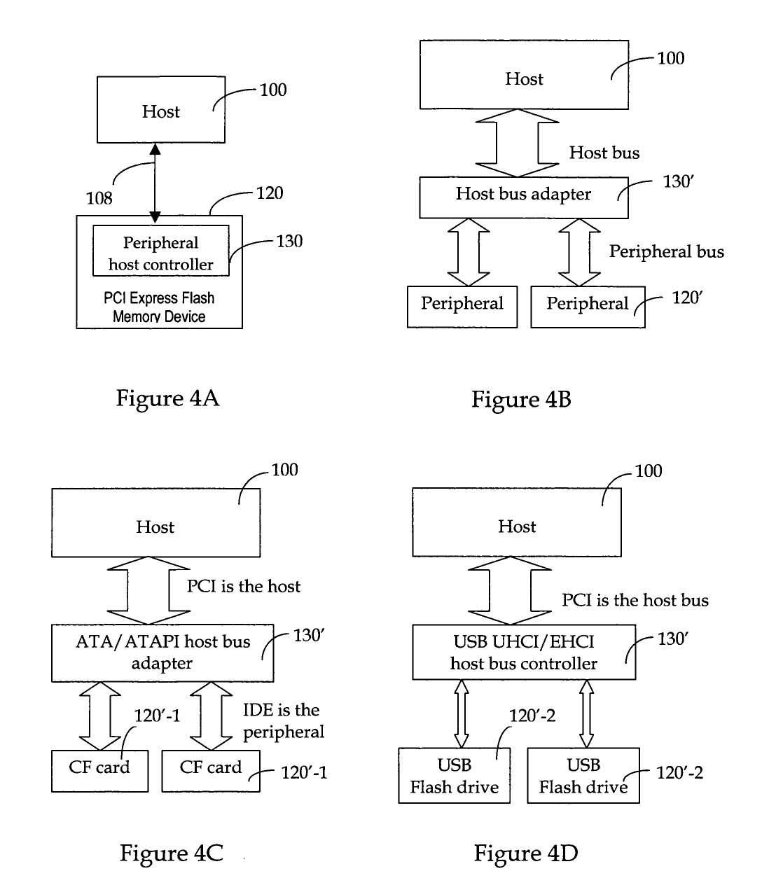

FIG. 4A is a first configuration for implementing the host bus interfacing configuration of a peripheral device 120, e.g., a PCI Express Flash Memory Device through the PCI Express interface to the host 100. The peripheral device includes a peripheral host controller 130 to perform the peer-to-peer interface functions via a PCI Express link 108 with the host as described above. FIG. 4B shows an alternate configuration of this invention for allowing a conventional peripheral device 120′, e.g., a CF card 120′-1 or a USB flash drive 120′-2 as that shown in FIGS. 4C and 4D respectively, to interface with the host 100 through a peripheral host controller 130′. The peripheral host controller 130′ is configured and implemented to perform all the functions as that described for the peripheral host controller 130 above such that the peripheral device 120′ together with a peripheral host controller 130′ can interface with the host as a mass storage device. The peripheral host controller 130′ provides connecting slots compatible with conventional USB and CF insertion configurations and function as a separate detachable external device for the host PC to adapt these conventional peripheral device to construct a mass storage device for interfacing with the host 100.

According to FIGS. 2 to 4 and above descriptions, this invention discloses a data handling system that includes a host computer for adapting a host bus adapting (HBA) device wherein the host bus adapting device interfacing with the host computer through exchanging peer-to-peer protocols. In a preferred embodiment, the HBA device further includes a data storage device. In another preferred embodiment, the HBA device further includes an externally detachable HBA device. In another preferred embodiment, the HBA device further includes an externally detachable HBA data storage device. In another preferred embodiment, the HBA device further includes a flash data storage device. In another preferred embodiment, the peer-to-peer link protocols further includes peer-to-peer link protocols defined in a PCI Express Standard. In another preferred embodiment, the external detachably adapting device further comprising an adapting link for adapting the externally adaptable device to the host computer for transferring the data between the external detachably adapting device and the host computer and for employing the peer-to-peer protocol. In another preferred embodiment, the external detachably adapting device further comprising a PCI Express Interface adapting link provided adapting the externally adaptable memory device to the host computer by attaching to a PCI Express Interface bus interface of the host computer for transferring the data between the external detachably adapting device and the host computer and for employing the peer-to-peer protocols.

In a preferred embodiment, this invention further discloses a data handling system that includes a host computer for adapting an external detachably adapting device wherein the external detachably adapting device interfacing with the host computer through exchanging peer-to-peer protocols. The external detachably adapting device further stores data for booting up the host computer immediately after a power-on operation of the host computer.

Although the present invention has been described in terms of the presently preferred embodiment, it is to be understood that such disclosure is not to be interpreted as limiting. Various alterations and modifications will no doubt become apparent to those skilled in the art after reading the above disclosure. Accordingly, it is intended that the appended claims be interpreted as covering all alterations and modifications as fall within the true spirit and scope of the invention.

1. A memory device for adapting to a host computer operated with an operating system wherein said memory device comprising:
a storage-device host controller provided for interfacing with said operating system (OS) of said host computer by employing peer-to-peer link protocols for transferring data between said memory device and said host computer.

2. The memory device of claim 1 wherein:
said memory device is an externally adaptable memory device for detachably adapting to said host computer.

3. The memory device of claim 1 wherein:
said peer-to-peer link protocols further comprising peer-to-peer link protocols defined in a PCI Express Standard.

4. The memory device of claim 1 wherein:
said memory device further comprising a host bus memory device and said peer-to-peer link protocols further comprising host bus protocols.

5. The memory device of claim 4 wherein:
said host bus protocols further comprising peer-to-peer link protocols defined in a PCI Express Standard.

6. The memory device of claim 1 further comprising:
an adapting link provided for adapting said memory device to said host computer for transferring said data between said memory device and said host computer and for employing said peer-to-peer link protocols.

7. The memory device of claim 1 further comprising:
an adapting link provided adapting said memory device to said host computer by attaching to a bus interface of said host computer for transferring said data between said memory device and said host computer and for employing said peer-to-peer link protocols.

8. The memory device of claim 1 further comprising:
a PCI Express Interface adapting link provided adapting said memory device to said host computer by attaching to a PCI Express Interface bus interface of said host computer for transferring said data between said memory device and said host computer and for employing said peer-to-peer link protocols as defined in a PCI Express Standard.

9. The memory device of claim 1 wherein:
said storage-device host controller provided for interfacing with said operating system (OS) of said host computer by employing peer-to-peer link protocols is further provided for carrying out a simultaneously bi-directional data transfer between said memory device and said host computer.

10. The memory device of claim 1 wherein:
said storage-device host controller further includes a mass storage host controller for interfacing with a mass storage device driver in said operating system (OS) of said host computer for carrying out a data transfer between said memory device and said host computer.

11. The memory device of claim 1 wherein:
said storage-device host controller further includes an ATA/ATPI mass storage host controller for interfacing with an ATA/ATPI mass storage device driver in said operating system (OS) of said host computer for carrying out a data transfer between said memory device and said host computer.

12. The memory device of claim 1 wherein:
said storage-device host controller further includes an SCSI mass storage host controller for interfacing with an SCSI mass storage device driver in said operating system (OS) of said host computer for carrying out a data transfer between said memory device and said host computer.

13. The memory device of claim 1 wherein:
said storage-device host controller further includes a proprietary mass storage host controller for interfacing with a proprietary mass storage device driver in said operating system (OS) of said host computer for carrying out a data transfer between said memory device and said host computer.

14. The memory device of claim 1 wherein:
said storage-device host controller further includes a mass storage host controller for performing command execution, data/status handling and address resolution for interfacing with a mass storage device driver in said operating system (OS) of said host computer for carrying out a data transfer between said memory device and said host computer.

15. A data handling system comprising:
a host computer for adapting a host bus adapting (HBA) device wherein said host bus adapting device interfacing with said host computer through exchanging peer-to-peer protocols.

16. The data handling system of claim 15 wherein:
said HBA device further comprising a data storage device.

17. The data handling system of claim 15 wherein:
said HBA device further comprising an externally detachable HBA device.

18. The data handling system of claim 15 wherein:
said HBA device further comprising an externally detachable HBA data storage device.
said external detachably adapting device further comprising a data storage.

19. The data handling system of claim 15 wherein:
said HBA device further comprising a flash data storage device.

20. The data handling system of claim 15 wherein:
said peer-to-peer link protocols further comprising peer-to-peer link protocols defined in a PCI Express Standard.

21. The data handling system of claim 15 wherein:
said host bus adapting (HBA)device further comprising a storage-device host controller provided for interfacing with an operating system (OS) of said host computer by employing said peer-to-peer protocols for transferring data between said host bus adapting device and said host computer

22. The data handling system of claim 17 wherein:
said external detachably adapting device further comprising an adapting link for adapting said externally adaptable device to said host computer for transferring said data between said external detachably adapting device and said host computer and for employing said peer-to-peer protocol.

23. The data handling system of claim 17 wherein:
said external detachably adapting device further comprising an adapting link provided adapting said externally adaptable device to said host computer by attaching to a bus interface of said host computer for transferring said data between said external detachably adapting device and said host computer and for employing said peer-to-peer protocols.

24. The data handling system of claim 17 wherein:
said external detachably adapting device further comprising a PCI Express Interface adapting link provided adapting said externally adaptable memory device to said host computer by attaching to a PCI Express Interface bus interface of said host computer for transferring said data between said external detachably adapting device and said host computer and for employing said peer-to-peer protocols.

25. The data handling system of claim 17 wherein:
said storage-device host controller for interfacing with said operating system (OS) of said host computer by employing said peer-to-peer protocols is further provided for carrying out a simultaneously bi-directional data transfer between said external detachably adapting device and said host computer.

26. The data handling system of claim 17 wherein:
said storage-device host controller further includes a mass storage host controller for interfacing with a mass storage device driver in said operating system (OS) of said host computer by employing a mass-storage peer-to-peer protocol provided for carrying out a data transfer between said external detachably adapting device and said host computer.

27. The data handling system of claim 17 wherein:
said storage-device host controller further includes an ATA/ATPI mass storage host controller for interfacing with an ATA/ATPI mass storage device driver in said operating system (OS) of said host computer by employing a mass-storage peer-to-peer protocol provided for carrying out a data transfer between said external detachably adapting device and said host computer.

28. The data handling system of claim 17 wherein:
said storage-device host controller further includes an SCSI mass storage host controller for interfacing with an SCSI mass storage device driver in said operating system (OS) of said host computer by employing a mass-storage peer-to-peer protocol provided for carrying out a data transfer between said external detachably adapting device and said host computer.

29. The data handling system of claim 17 wherein:
said storage-device host controller further includes a proprietary mass storage host controller for interfacing with a proprietary mass storage device driver in said operating system (OS) of said host computer by employing a mass-storage peer-to-peer protocol provided for carrying out a data transfer between said external detachably adapting device and said host computer.

30. The data handling system of claim 17 wherein:
said storage-device host controller further includes a proprietary mass storage host controller for performing command execution, data/status handling and address resolution for interfacing with a proprietary mass storage device driver in said operating system (OS) of said host computer by employing a mass-storage peer-to-peer protocol provided for carrying out a data transfer between said external detachably adapting device and said host computer.

31. A data handling system comprising:
a host computer for adapting an external detachably adapting device wherein said external detachably adapting device interfacing with said host computer through exchanging peer-to-peer protocols; and
said external detachably adapting device further storing data for booting up said host computer immediately after a power-on operation of said data handling system.

32. A method for booting a host computer comprising:
adapting an external detachably adapting device to said host computer and enabling said external detachably adapting device to interface with said host computer through exchanging peer-to-peer protocols; and
storing operating system in said external detachably adapting device ready to load into said host computer immediately for booting up after a power-on operation of said host computer.

33. A data handling system comprising:
a host computer for adapting an external detachably adapting device wherein said external detachably adapting device includes a peripheral host adapting (HBA) controller for interfacing with said host computer for exchanging peer-to-peer protocols; and
said external detachably adapting device further includes at least an insertion slot for adapting a peripheral data storage device therein.

34. The data handling system of claim 33 wherein:
said peripheral data storage device is a CF card data storage device.

35. The data handling system of claim 33 wherein:
said peripheral data storage device is a USB flash drive data storage device.

36. The data handling system of claim 33 wherein:
said peripheral data storage device further storing operating system for ready to load into said host computer immediately for booting up said host computer after a power-on operation of said host computer.
